(19) United States
(12) Patent Application Publication
(10) Pub. No.: US 2025/0251984 A1
(43) Pub. Date: Aug. 7, 2025

(54) Computer System and Computer-Implemented Method for Executing Computing Jobs Spanning Security Boundaries

(71) Applicant: Shopify Inc., Ottawa (CA)

(72) Inventor: Timothy WILLARD, Kitchener (CA)

(73) Assignee: Shopify Inc., Ottawa (CA)

(21) Appl. No.: 18/433,854

(22) Filed: Feb. 6, 2024

(51) Int. Cl. G06F 9/50

(52) U.S. Cl. CPC G06F 9/5038; G06F 9/5072

(57) ABSTRACT

A computer system and computer-implemented method are provided for executing computing jobs that span security boundaries. The method includes, in executing a batch processing job comprising at least one task to be performed for each of a plurality of entities associated with a plurality of different security zones spanning at least one security boundary obtaining a plurality of data items each associated with entities of the plurality of entities. The method also includes, while performing the at least one task, prior to mutating data based on one or more of the data items of the plurality of data items, cross-referencing the indications associated with the plurality of data items to validate ownership of the data items.

### TECHNICAL FIELD

The following relates generally to executing computing jobs, in particular to executing computing jobs that span security boundaries, for example in executing batch computing jobs that span tenant partitions and associated security boundaries.

### BACKGROUND

To scale a large orchestration system, a cross-tenant job execution system, or a job scheduler for jobs that span tenant partitions; batch processing or “batching” may be utilized for efficiency. That is, to run such a large orchestration system without batching may be inefficient due to the overhead of running a job and the overhead of database operations in a distributed system.

### BRIEF DESCRIPTION OF THE DRAWINGS

Embodiments will now be described with reference to the appended drawings wherein:

FIG. 1 is an example of a computing environment in which a software platform is utilized by multiple tenants.

FIG. 2 is an example of a software platform hosting a database having multiple tenant partitions separated by security boundaries, the database being accessed in performing tasks using a batch processor.

FIG. 3a illustrates a data access stage in a batch computing job.

FIG. 3b illustrates task execution and ownership validation during the batch computing job.

FIG. 3c illustrates a data rewriting stage in the batch computing job.

FIG. 4 is a flow chart illustrating example operations for executing batch computing jobs that span tenant partitions and associated security boundaries.

FIG. 5 illustrates an example of a task having multiple intermediate checkpoints during execution of the task in a batch processing job.

FIG. 6 is an example of a computing device operable to communicate in the computing environment.

FIG. 7 is a flow chart illustrating example operations for cross-referencing indications associated with data items to validate ownership of the data items associated with a corresponding entity.

FIG. 8 is a flow chart illustrating example operations for executing a task that includes writing data back to a database.

FIG. 9 is a flow chart illustrating example operations for executing a task having multiple intermediate checkpoints.

FIG. 10 is a flow chart illustrating example operations for resuming a failed task from an intermediate checkpoint based on a prior successful validation.

### DETAILED DESCRIPTION

While batch processing of computing jobs may be utilized for efficiency, it is recognized that, with batch processing, traditional solutions may have limitations. For example, traditional solutions to the insecure direct object reference (IDOR) security pattern may not work, since the orchestrator may run batches for multiple (e.g., hundreds) of users/accounts in a batch, and checking whether the correct owners are requesting their own data may be extremely slow and inefficient. Moreover, batch processing (also referred to herein as “batching”) may create security risks due to cross-contamination of data from one user/account to another user/account. This cross-contamination may arise inadvertently, or due to malicious activities, both of which should be prevented.

As data in a cross-tenant/cross-user job is fetched for processing, by having a user/account identifier or indication (referred to herein as an “ID”) associated with, or otherwise corresponding to (e.g., stored with), the data that is being fetched and processed when batch processing, validation of the data may be made shortly or just before the time when it is being processed, rather than as the data is being fetched. In this way, cross-contamination may be avoided by ensuring ownership after the point when the cross-contamination (or malicious activity) could occur (e.g., between fetching the data and writing processed/modified/mutated data back to the database).

The data being fetched when batch processing may include multiple types of data that each have the user/account ID associated with the data such that multiple validations of the owner's data can be performed prior to executing a task that uses the data. For example, to execute a task in a batch process within a distributed system, each task may utilize trigger parameters, metadata, and orchestration data. Additional data may additionally be generated while running the task and be associated with the other types of data used in executing the task. By having the user/account ID stored with each set of data, the system may cross-reference the user/account IDs to ensure that each type of data identifies the correct party. In other words, the IDs may be used to effectively model the security boundaries of/for the data at a higher level without potentially costly identification checks when accessing such data.

The cross-referencing may be performed just prior to making any modifications to the data used in the batch process to ensure that the data has not been tampered with or that the requesting party is not a malicious actor. While the above example includes three or four types of data that may be used to cross-reference with the requesting party, any plurality of types of data may be used to perform the cross-reference and validation.

In batch processing, there may be multiple checkpoints during execution of a task. The validation of the user/account ID may be performed at each checkpoint such that any disruption of the process may be reset to the last checkpoint where the ID was validated.

In such a configuration, the data generated while the task is running may be tagged with the user/account ID. At checkpoints, any data generated at that checkpoint may also be validated to, and tagged with, the user/account ID such that if a subsequent stage in the process is disrupted, crashes or fails, a resumption may be attempted at the last checkpoint where the user/account ID has been validated. It may be noted that a checkpoint may include a passive step, where a validation is not required (e.g., no modifications are made), or an active step, where a validation is required.

As described herein, a successful execution of a task performed when batching may include a validation of the user/account ID at each checkpoint or other step or stage where authorization to perform the step or stage in the task should be validated to the actual owner of the data. For example, the task may include reading data, processing data, validating the user/account ID, and writing modified/processed data back to a database. By validating at any one or more checkpoints, in the event of a failure of the task, the system may determine if there was a checkpoint that validated to the user/account ID and resume from that point. Moreover, by validating the user/account ID before writing back modified data rather than immediately when reading the data, any malicious or erroneous activities performed in between may be detected and dealt with.

The same principles may be applied to other configurations, whether checkpoints are included or not, or any one or more steps or stages are performed according to the definition of the task being executed.

In one aspect, there is provided a computer-implemented method, comprising: in executing a batch processing job comprising at least one task to be performed for each of a plurality of entities associated with a plurality of different security zones spanning at least one security boundary: obtaining a plurality of data items each associated with entities of the plurality of entities, the data items to be used in performing the at least one task; and associating data items of the plurality of data items with indications of the entities of the plurality of entities associated therewith. The method also includes, while performing the at least one task, prior to mutating data based on one or more of the data items of the plurality of data items, cross-referencing the indications associated with the plurality of data items to validate ownership of the data items associated with a corresponding entity of the plurality of entities associated therewith.

In certain example embodiments, the cross-referencing comprises comparing the indications associated with the plurality of data items to confirm that the indications match.

In certain example embodiments, the method further includes, in performing the cross-referencing while repeating the method, responsive to determining that at least one of the indications does not match at least one other indication, disallowing the mutating.

In certain example embodiments, the method further includes initiating an error condition responsive to disallowing the mutating.

In certain example embodiments, the indications identify a corresponding user or account associated with the plurality of data items to cross-reference against an entity requesting that the at least one task be performed.

In certain example embodiments, the at least one task comprises reading a particular data item, mutating the particular data item, validating the corresponding indication using a plurality of related data items of the corresponding associated entity, and writing the particular data item back to a database.

In certain example embodiments, the batch processing job is executed in a distributed computing system.

In certain example embodiments, the plurality of data items comprises any one or more of trigger parameters, metadata, and orchestration data.

In certain example embodiments, the plurality of data items comprises data generated while executing the particular task.

In certain example embodiments, the at least one task comprises at least one checkpoint during execution thereof, and the method further includes validating ownership of the data items associated with the corresponding entity at each checkpoint.

In certain example embodiments, the method further includes, responsive to a failure during execution of the at least one task, determining that a particular checkpoint of the at least one checkpoint has validated the ownership of the data items; and resuming the at least one task from the particular checkpoint.

In certain example embodiments, the method further includes, responsive to the ownership of the data items being validated, complete the at least one task by mutating the data and writing the mutated data back to a database.

In another aspect, there is provided a computer system comprising at least one processor; and at least one memory, the at least one memory comprising processor executable instructions that, when executed by the at least one processor, cause the computer system to, in executing a batch processing job comprising at least one task to be performed for each of a plurality of entities associated with a plurality of different security zones spanning at least one security boundary: obtain a plurality of data items each associated with entities of the plurality of entities, the data items to be used in performing the at least one task; and associate data items of the plurality of data items with indications of the entities of the plurality of entities associated therewith. The computer system also includes instructions that, when executed by the at least one processor, cause the computer system to, while performing the at least one task, prior to mutating data based on one or more of the data items of the plurality of data items, cross-reference the indications associated with the plurality of data items to validate ownership of the data items associated with a corresponding entity of the plurality of entities associated therewith.

In certain example embodiments, the cross-referencing comprises comparing the indications associated with the plurality of data items to confirm that the indications match.

In certain example embodiments, the computer system further includes instructions that, when executed by the at least one processor, cause the computer system to, in performing the cross-referencing while repeating the operations, responsive to determining that at least one of the indications does not match at least one other indication, disallow the mutating.

In certain example embodiments, the computer system includes instructions that, when executed by the at least one processor, cause the computer system to initiate an error condition responsive to disallowing the mutating.

In certain example embodiments, the indications identify a corresponding user or account associated with the plurality of data items to cross-reference against an entity requesting that the at least one task be performed.

In certain example embodiments, the at least one task comprises at least one checkpoint during execution thereof, and the method further comprises validating ownership of the data items associated with the corresponding entity at each checkpoint.

In certain example embodiments, the computer system includes instructions that, when executed by the at least one processor, cause the computer system to: responsive to a failure during execution of the at least one task, determine that a particular checkpoint of the at least one checkpoint has validated the ownership of the data items; and resume the at least one task from the particular checkpoint.

In another aspect, there is provided a computer-readable medium comprising processor executable instructions that, when executed by a processor of a computer system, cause the computer system to: in executing a batch processing job comprising at least one task to be performed for each of a plurality of entities associated with a plurality of different security zones spanning at least one security boundary: obtain a plurality of data items each associated with entities of the plurality of entities, the data items to be used in performing the at least one task; and associate data items of the plurality of data items with indications of the entities of the plurality of entities associated therewith. The computer-readable medium further includes instructions that, when execute by the processor of the computer system, cause the computer system to, while performing the at least one task, prior to mutating data based on one or more of the data items of the plurality of data items, cross-reference the indications associated with the plurality of data items to validate ownership of the data items associated with a corresponding entity of the plurality of entities associated therewith.

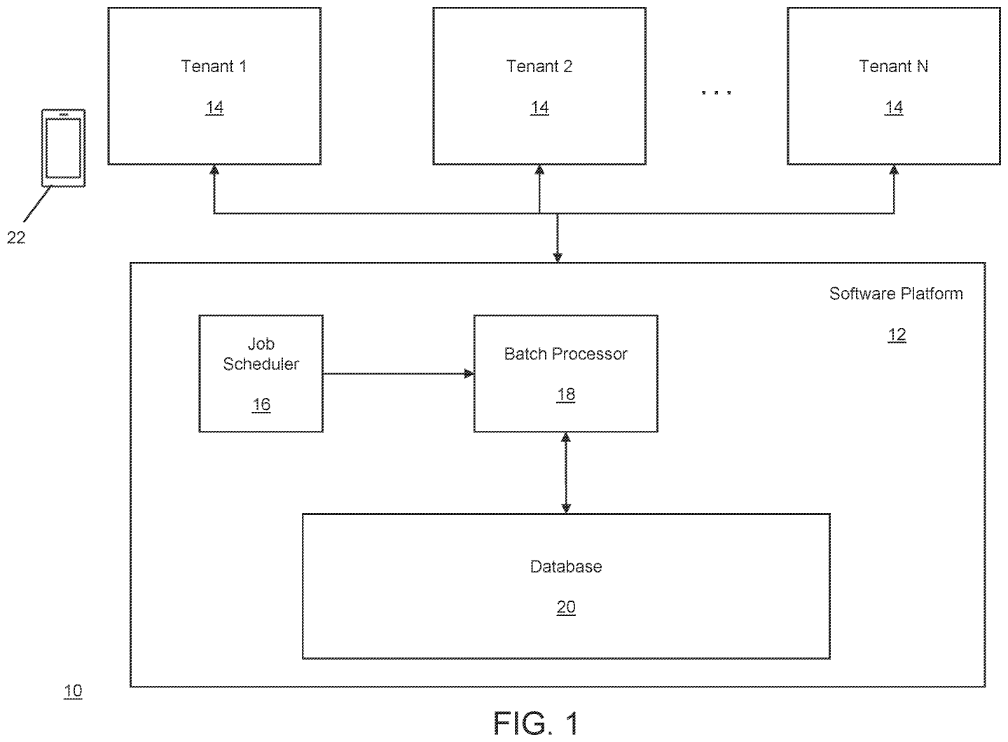

Turning now to the figures, FIG. 1 illustrates an example of a computing environment 10. The computing environment 10 in this example includes a software platform 12, which may be adapted as a SaaS platform such as, for example, an e-commerce platform, media distribution platform, security infrastructure platform, etc. The software platform 12 may be, or be part of, a distributed computing system. The software platform 12 in this example is coupled to a plurality of tenants 14. In this example an arbitrary “N” number of tenants 14 is shown, i.e., Tenant 1, Tenant 2, . . . , Tenant N. The tenants 14 are also part of the distributed computing system in which the software platform 12 operates, which may at least in part be operated for or on behalf of the tenants 14. It can be appreciated that the entities shown in FIG. 1 may communicate or otherwise be coupled to each other via one or more communication connections, which may utilize one or more short- or long-range communication network protocols, described by way of example below.

The software platform 12 in this example includes, among other things not shown for ease of illustration, a batch processer 18 that is instructed or otherwise in communication with a job scheduler 16. The batch processor 18 and job scheduler 16 may be used to provide the functionality associated with an orchestration system or cross-job execution system or any other configuration used to schedule and execute jobs that span tenant partitions and associated security boundaries. The batch processor 18 is also coupled to and in communication with a database 20. The database 20 at least in part stores data on behalf of each of the tenants 14 within the distributed computing environment 10. As such, the database 20 includes a plurality of partitions that include one or more security boundaries, whether physical or logical, to protect cross-contamination between data associated with specific tenants 14.

The software platform 12, either directly or indirectly (via the tenants 14 or other entities (not shown) within the computing environment 10), may interact with various client devices 22, which may include user devices or devices operated by other computing entities. The client devices 22 may, for example, interact with the software platform 12, via or by a tenant 14, to obtain access to content or services and this may involve the software platform 12 and other entities in the computing environment 10, e.g., within an e-commerce or media distribution environment. Any such access to content or services may include, whether in real-time or in a background process at some other time, involve the batch processor 18 interacting with a tenant's data stored in the database 20. While a single database 20 is shown for ease of illustration, it can be appreciated that multiple storage elements may be accessed and utilized according to the same principles as those discussed herein.

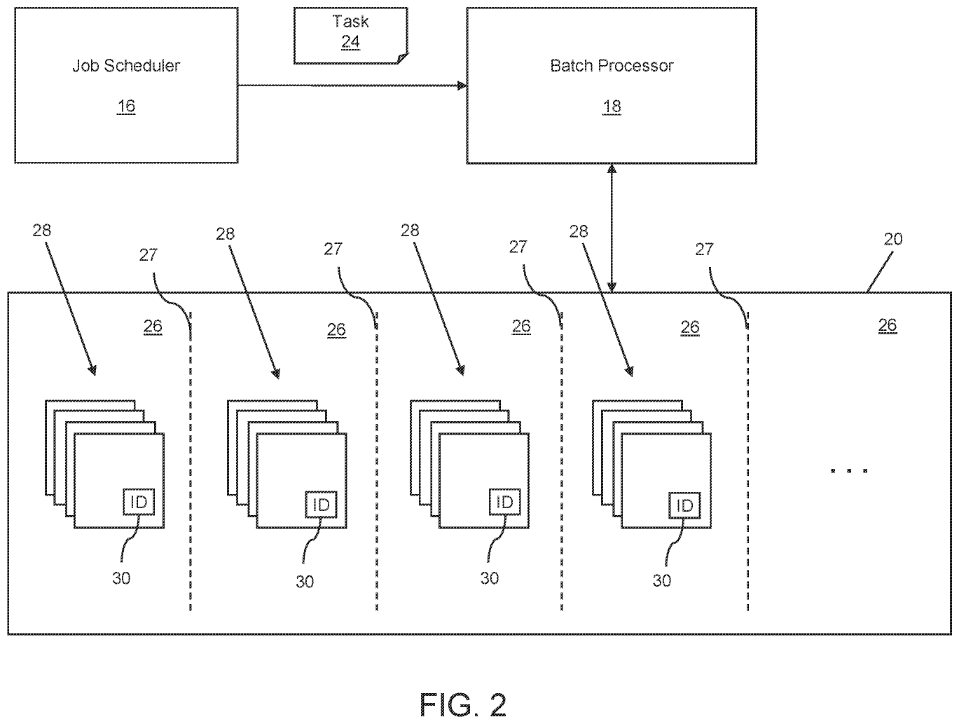

FIG. 2 illustrates further detail concerning the database 20. The job scheduler 16 coordinates with the batch processor 18 to execute a task 24 for the tenants 14 or in operating the software platform 12 for the tenants 14, e.g., to execute batch processing of a system-wide job, which may include an update, upgrade, creation or distribution of a new feature or new content, rolling out a new service, performing a periodic backend process, executing a computing function, etc. In this example, the task 24 is provided by the job scheduler 16 to the batch processor 18, however, this may include an instruction to have a task 24 executed. That is, the task 24 shown in FIG. 2 is illustrative of the existence and initiation of a task 24 to be executed by the batch processor 18 for or by the software platform 12.

The task 24 in this example includes, at least in part, access to, and at least some processing/editing/modifying or other “mutation” of, data associated with the tenants 14. In the configuration shown in FIG. 2, the database 20 includes a plurality of partitions 26. Each partition 26 is allocated to or otherwise associated with a corresponding tenant 14 and is separated from other partitions 26 by a security boundary 27.

The batch processor 18 and job scheduler 16 may therefore be used to execute jobs that include at least one task 24 that spans a security boundary 27, which can create problems with computer security and is normally avoided. It has been recognized that the risk of spanning such security boundaries 27 can be mitigated by associating the tenant data 28 with an indication of the zone (which corresponds to a database partition 26 in this example and the zone being equivalent to a single trust level//area from which the tenant data 28 comes (e.g., user/account)), maintaining that association during processing, and then checking when storing data back that nothing is moving cross partition by checking for a match between the target zone and the indication or identifier. Effectively, this mirrors the security boundaries 27 in the in-memory data, providing similar security assurances to those lower-level security restrictions being bypassed (for efficiency) at a higher level. Performing security checks in this way is found to be more efficient than a “naïve” approach of doing each job multiple times, one zone at a time.

The security boundaries 27 may be physical or logical (or both). While the security boundaries 27 inhibit cross-contamination of tenant data 28 stored in respective partitions 26, it is recognized that by obtaining data 28 from the database 20 in executing a task 24 by the batch processor 18, vulnerabilities may exist where data 28, when written back to the database 20, cross-contaminates a partition 26, is otherwise compromised or is at least misplaced (to pose a potential privacy or confidentiality issue), and ends up being written to an incorrect partition 26.

As shown, each partition 26 may store multiple data items, collectively referred to as the tenant data 28. The data items in the tenant data 28 may be individual data items or sets of data items. Some tenant data 28 may be read-only, while other tenant data 28 may be capable of, or otherwise be permitted to be, mutated (e.g., edited or augmented) and written back to the respective partition 26 in the database 20.

Each data item of the tenant data 28 may include an identifier or indication, collectively denoted by the acronym “ID”, and referred to by numeral “30”. The ID 30 may be associated with a data item of the tenant data 28 in various ways, for example, by tagging the tenant data 28 with the ID 30, populating a look-up table, including a pointer, or any other suitable identifier or identification mechanism. By associating each data item of the tenant data 28 with an ID 30 that indicates ownership of the data 28, the ID 30 may be used in a validation step prior to enabling mutated data to be written back to the database 20 to a particular partition and/or prior to enabling the mutation to be applied. For example, the ID 30 may be used prior to writing tenant data 28 to a particular data partition 26 to ensure that the tenant data 28 belongs to the owner of that partition 26, e.g., a particular tenant 14 within the computing environment 10. This inhibits and may prevent tenant data 28 from crossing the physical or logical security boundaries 27 that are meant to be enforced by the software platform 12 on behalf of the tenants 14 (e.g., inhibit data being stored in the wrong partition 26 and inadvertently be divulged to the incorrect owner).

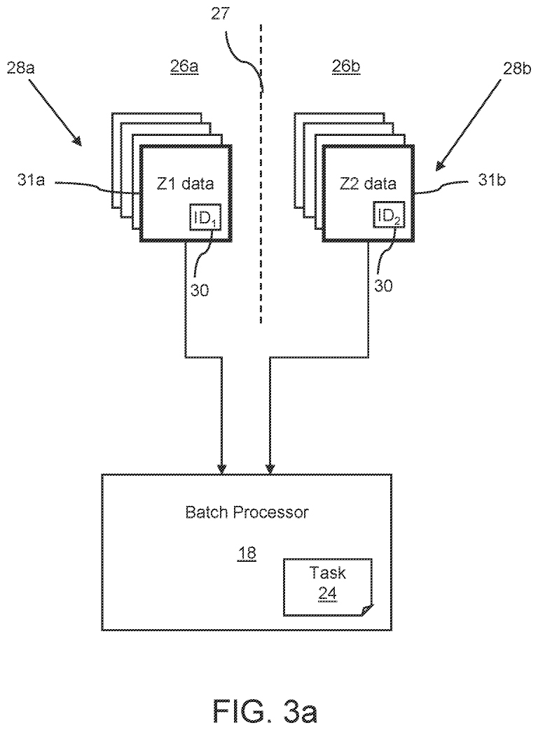

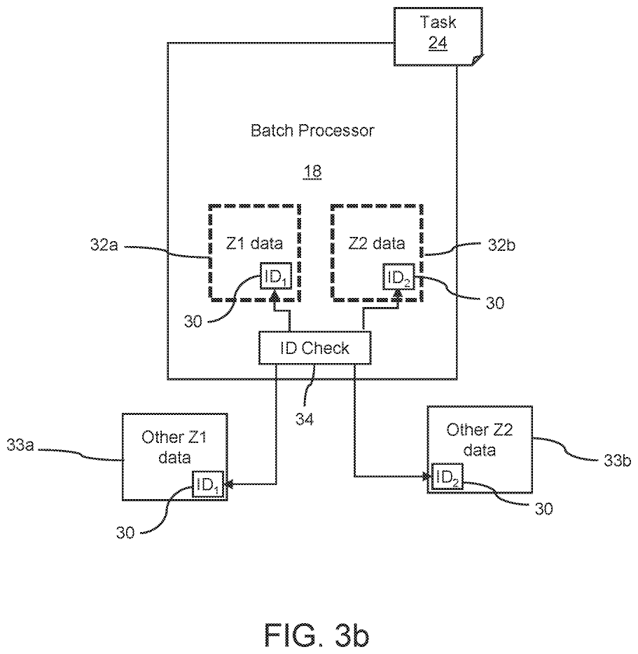

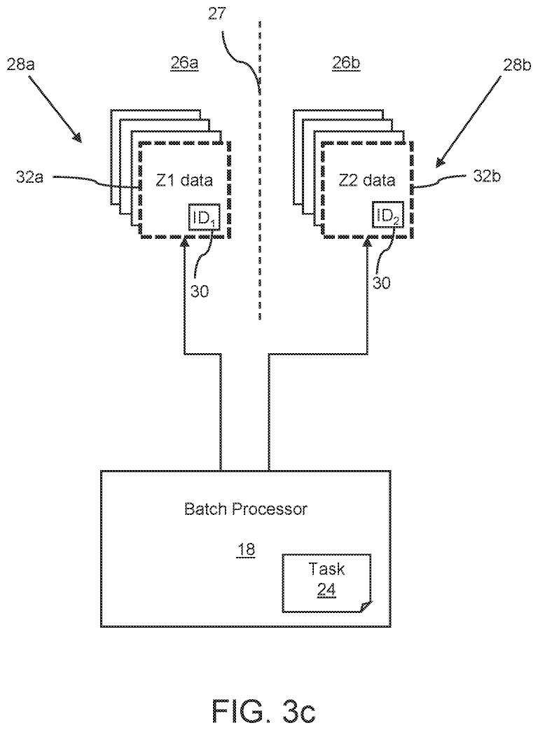

FIGS. 3a, 3b, and 3c illustrate an example of a data mutation and ownership validation performed by the batch processor 18 when interacting with tenant data 28 in the database 20. In this example, tenant data 28a in a first data partition 26a is accessed by the batch processor 18 in a batch computing job that also involves accessing tenant data 28b in a second data partition 26b that is separated from the first data partition 26a by a security boundary 27. In this example, a first data item 31a from the first data partition 26a is identified as zone 1 (Z1) data and includes an ID 30 that corresponds to the tenant 14 to whom the data 28a belongs. The first data item 31a is meant to be mutated (e.g., edited, augmented, transformed, encrypted, deleted, etc.) as part of executing the task 24. A second data item 31b from the second partition 26b is identified as zone 2 (Z2) data and includes an ID 30 that corresponds to the tenant 14 to whom the data 28b belongs. The second data item 31b is also meant to be mutated as part of executing the task 24. The first and second data items 31a, 32b are obtained by the batch process 18 in executing the task 24.

Referring now to FIG. 3b, the batch computing job is illustrated as being implemented by the batch processor 18 in executing the task 24, which may be, or be part of, a batch computing job. In this example, the first data item 31a from the first partition 26a is mutated to create a first mutated data item 32a. The second data item 31b from the second partition 26b is also mutated to create a second mutated data item 32b. In executing the task 24, other data 33 is created or already exists, which is also tagged with the ID 30 of the corresponding owner of the corresponding data partition 26a. For example, as noted above, orchestration data, metadata, and parameter data may each be tagged with the ID 30 such that multiple data items 31, 32, 33 may be cross-referenced using the ID 30 to validate ownership of the mutated data 32. In this example, first other data 33a is/are used to validate ownership of the Z1 data using the ID 30 identified as ID1 in FIG. 3b. Similarly, second other data 33b is/are used to validate ownership of the Z2 data using the ID 30 identified as ID2 in FIG. 3b. That is, by tagging a plurality of data items associated with a particular tenant 14 using the same ID 30, prior to writing a mutated data item 32 back to the database 20, ownership of the mutated data item 32 may be validated as close to the time of writing that data back to the database 20 as possible, to safeguard against any cross-contamination that may occur or be maliciously applied during execution of the task 24, e.g., when compared to performing such a validation earlier such as at the time of accessing each data item 31.

Thus, prior to writing the mutated data items 32a, 32b back to the database 20 as shown in FIG. 3c, an ID check 34 may be performed by the batch processor 18 as shown in FIG. 3b. The ID check 34 may identify the existence of an ID 30 associated with multiple items of tenant data 28 that is used or generated in executing a task 24, to ensure that the ownership of any mutated data 32 is verified. For example, if an ID 30 cannot be found on/in or in association with the mutated data item 32 or the ID 30 is incorrect, an error condition may be initiated and the mutating reversed, discarded or prevented from happening (depending on the timing of the ID check 34).

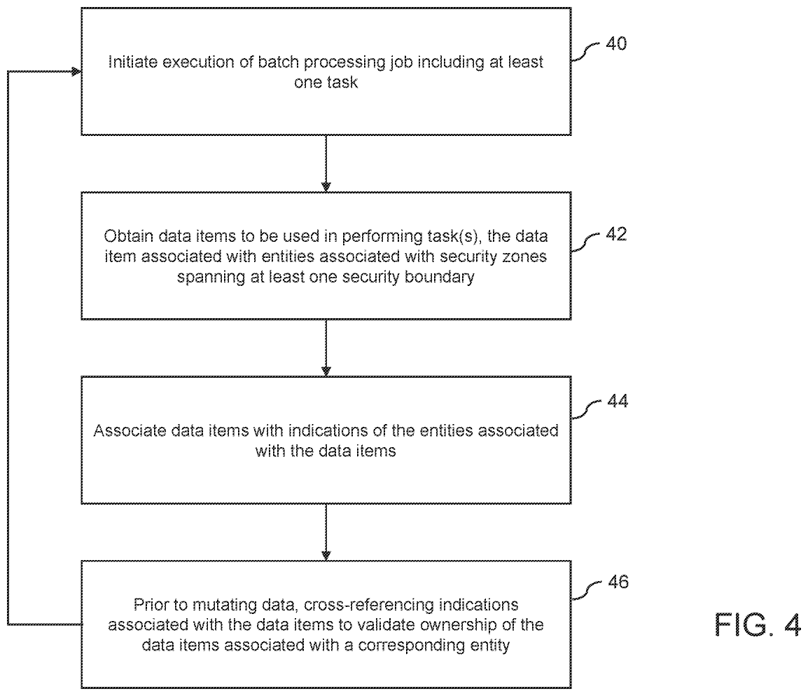

Referring now to FIG. 4, a flow chart is provided illustrating example operations for executing batch computing jobs that span tenant partitions 26 and associated security boundaries 27, e.g., as illustrated in FIGS. 3a-3c. At block 40, execution of a batch processing job is initiated and that batch processing job includes at least one task 24.

At block 42, data items 31, 33 that are to be used in performing one or more tasks 24 are obtained. For example, the data item 31 that is to be processed/mutated to create the mutated data item 32, as well as any other data 33 that is associated with the same tenant 14, is obtained or received and utilized in performing the task(s) 24. At least the data items 31a, 31b are associated with entities such as tenants 14 (e.g., Tenant 1 and Tenant 2) that are associated with security zones (e.g., Z1 and Z2) that span at least one security boundary 27, e.g., as shown in FIG. 3a.

At block 44, indications (IDs) 30a, 3b are associated with the entities (e.g., Tenant 1 and Tenant 2) that are associated with the data items 31a/33a, 31b/33b.

At block 46, prior to mutating data (e.g., mutating data items 31a, 31b to created mutated data items 32a, 32b), the batch processor 18 may utilize the ID check 34 to cross-reference IDs 30 associated with the data items 31/33 to validate the ownership of the data items 31/33 associated with a corresponding entity (e.g., Tenant 1 or Tenant 2).

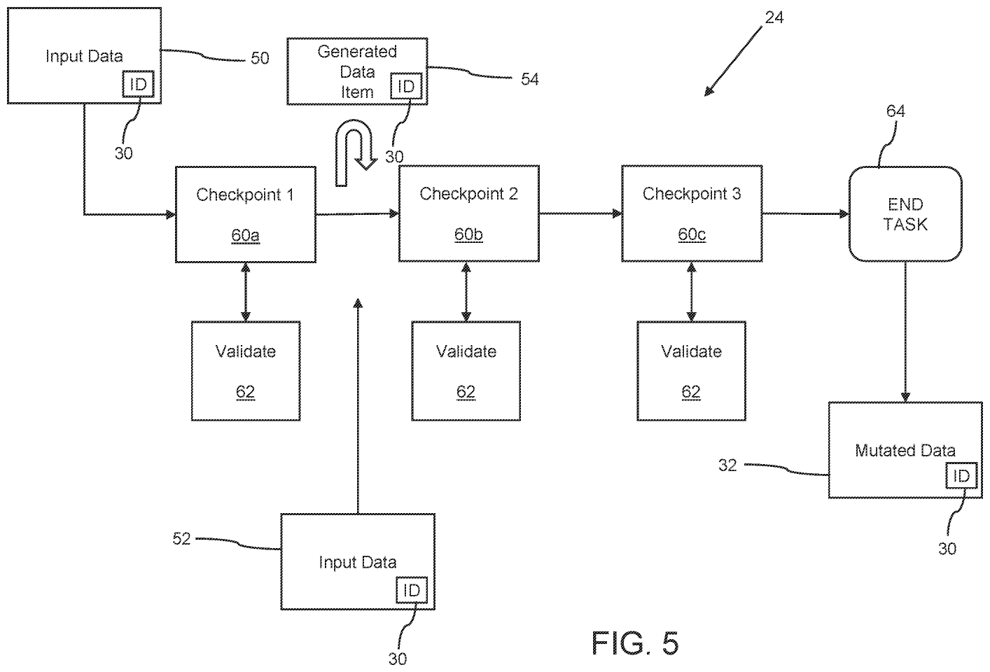

The task 24 shown in FIGS. 3a-3c includes a single ownership validation by utilizing the ID check 34. However, such tasks 24 may themselves include multiple portions, stages, or steps, or be considered sub-tasks or multi-tasks according to other phraseologies, applications, configurations, or specifications. FIG. 5 illustrates an example of a multi-stage task that includes multiple checkpoints 60, in this example a first checkpoint 60a referred to as Checkpoint 1, a second checkpoint 60b referred to as Checkpoint 2, and a third checkpoint 60c referred to as Checkpoint 3, prior to an end task condition 64. The task 24 in this example includes multiple input data items 50, 52, each including an ID 30 to identify the owner of those input data items 50, 52. The first input data item 50 feeds into a first stage of the task 24 that includes the first checkpoint 60a. At the first checkpoint 60a, a validation step 62 is performed, e.g., using the ID check 34 or other process. Execution of the task 24 may involve generating a new data item 54 and the ID 30 associated with the input data items 50, 52 may be added 30 or otherwise associated with the newly generated data item 54 to permit it to be used in validating the input data items 50, 52 or other data generated during execution of the task 24.

The task 24 shown in FIG. 5 progresses through multiple stages and includes two additional checkpoints 60b, 60c, each having a validation step 62 performed. The results of the validations 62 may be logged such that if execution of the task 24 is interrupted, the task 24 may be resumed at the last checkpoint 60 that included a successful ownership validation.

After reaching the end task condition 64, which may or may not include any additional processing/mutating, the mutated data 32 that was generated at some point during execution of the task 24, which includes the ID 30 that was validated at least at the final validation step 62, may be written back to the database 20 in the associated partition 26.

The stages of the task 24 and checkpoints 60 between such stages may represent various sub-tasks or processing steps. For example, a checkpoint 60 may be inserted at the point of processing tenant data 28. The checkpoint 60 may, additionally or alternatively, be inserted at a point of processing based on a level of sensitivity of the data, e.g., personal data, security data, financial information, etc. The checkpoints 60 may be inserted at the point of storing or saving a progress of the task 24 or storing intermediate results or mutations within the task 24. As such, the checkpoints 60 may be inserted at any point that a validation of the data being mutated is desired. The checkpoints 60 may be used to validate ownership of the data 50, 52, 54 when an application programming interface (API) is invoked, when a cryptographic process is to be implemented or any other suitable sub-task, processing step or stage or when any action is taken.

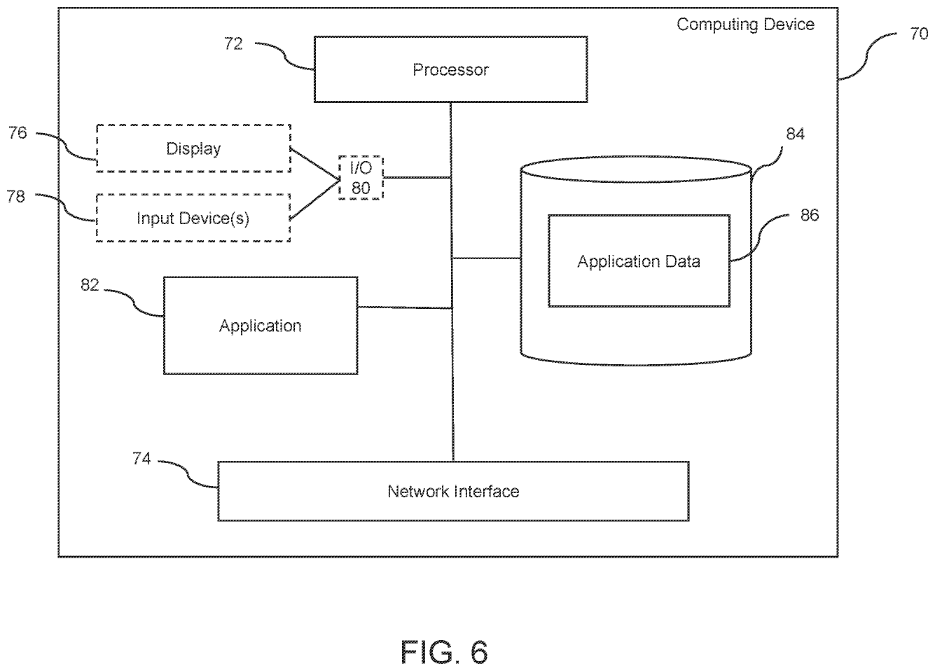

FIG. 6 shows an example of a computing device 70 which may be utilized by any of the entities shown in FIGS. 1 and 2, for example, the software platform 12, tenants 14, job scheduler 16, batch processor 18, or user device 22, and be adapted for the corresponding role of that entity. In this example, the computing device 70 includes one or more processors 72 (e.g., a microprocessor, microcontroller, embedded processor, digital signal processor (DSP), central processing unit (CPU), media processor, graphics processing unit (GPU) or other hardware-based processing units) and one or more network interfaces 74 (e.g., a wired or wireless transceiver device connectable to a network via a communication connection). Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 70 also includes an application 82, a data store 84, and application data 86. It can be appreciated that the application 82 may represent an application provided by the software platform 12 to enable the computing device 70 to act as, for example, a tenant 14 or as an internal device such as the batch processor 18. The application 82 may instead represent an application provided or used by the user device 22 to communicate with or on behalf of a tenant 14 within the computing environment 10.

The data store 84 may represent a database or library or other computer-readable medium configured to store data and permit retrieval of data by the computing device 70. The data store 84 may be read-only or may permit modifications to the data. The data store 84 may also store both read-only and write accessible data in the same memory allocation. In this example, the data store 84 stores the application data 86 for the application 82 that is configured to be executed by the computing device 70 for a particular role or purpose.

While not delineated in FIG. 6, the computing device 70 includes at least one memory or memory device that can include a tangible and non-transitory computer-readable medium having stored therein computer programs, sets of instructions, code, or data to be executed by processor(s) 72. The processor(s) 72 and network interface(s) 74 are connected to each other via a data bus or other communication backbone to enable components of the computing device 70 to operate together as described herein. FIG. 6 illustrates examples of modules and applications stored in memory on the computing device 70 and executed by the processor(s) 72.

It can be appreciated that any of the modules and applications shown in FIG. 6 may be hosted externally and be available to the computing device 70, e.g., via a network interface 74. The data store 84 in this example stores, among other things, the application data 86 that can be accessed and utilized by the application 82. The data store 84 may additionally store one or more software routines in a cache or in other types of memory.

As shown in FIG. 6, the computing device 70 may, optionally (e.g., when configured as a user device 22), include a display 76 and one or more input device(s) 78 that may be utilized via an input/output (I/O) module 80. That is, such components may be omitted when the computing device 70 does not interact with a user.

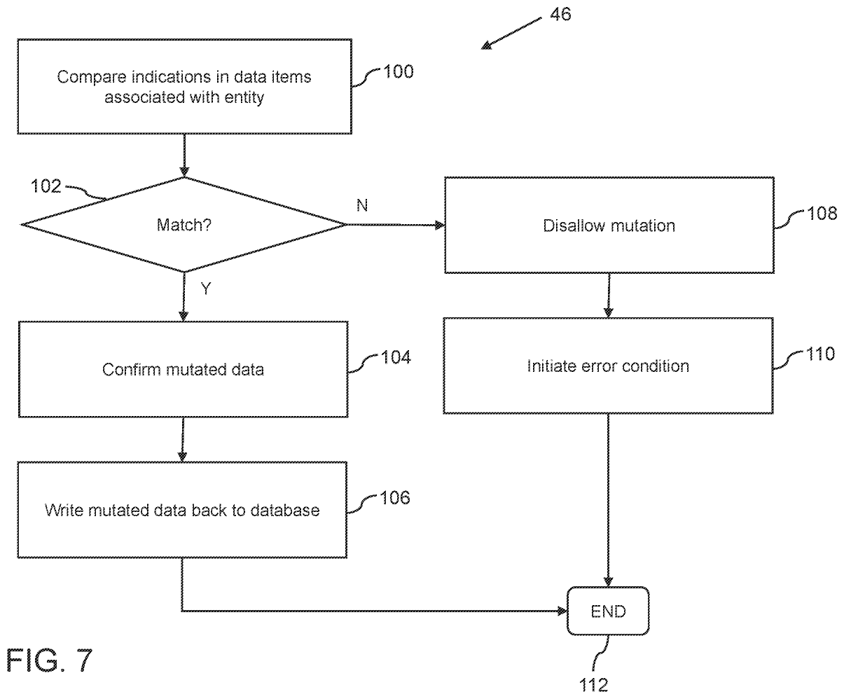

Referring now to FIG. 7, a flow chart is provided illustrating example operations for cross-referencing IDs 30 associated with data items 31, 33 to validate ownership of the data items 31, 33 associated with a corresponding entity (e.g., tenant 14). As shown in FIG. 7, the operations illustrated in FIG. 7 may be executed as part of block 46 shown in FIG. 4.

At block 100, the IDs 30 in or associated with the data items 31, 33 that identify the corresponding entity are compared to determine, at block 102, whether the IDs 30 match.

If so, the mutated data 32 is confirmed at block 104, which may confirm already mutated data or permit a data item 31 to be mutated to create a corresponding mutated data item 32 as shown in FIG. 3b. At block 106, the mutated data 32, which has been confirmed, is written back to the database 20 as shown in FIG. 3c and the process ends at block 112.

If at least one ID 30 does not match, at block 102, the mutation is disallowed at block 108. This may include discarding an already mutated data item 32 or preventing the mutation from occurring to begin with.

At block 110, an error condition may be initiated to indicate that a potential cross-contamination has been prevented, e.g., to initiate a further or deeper check of a particular data partition 26 to confirm no further issues have arisen.

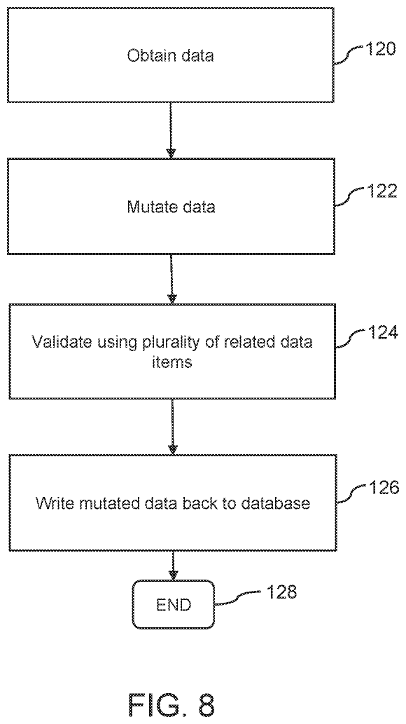

Referring now to FIG. 8, a flow chart is provided illustrating example operations for executing a task 24 that includes writing data back to the database 20. At block 120, the data item(s) 31, 33 are obtained. At block 122, at least one data item 31, 33 is mutated to create a mutated data item 32.

At block 124, the plurality of related data items 31, 33 are used to validate the ownership of the data items 31, 33 and the mutated or to-be-mutated data item 32. On the assumption that the validation at block 124 is successful, the mutated data 32 is written back to the database 20 at block 126, as shown in FIG. 3c and the process ends at block 128.

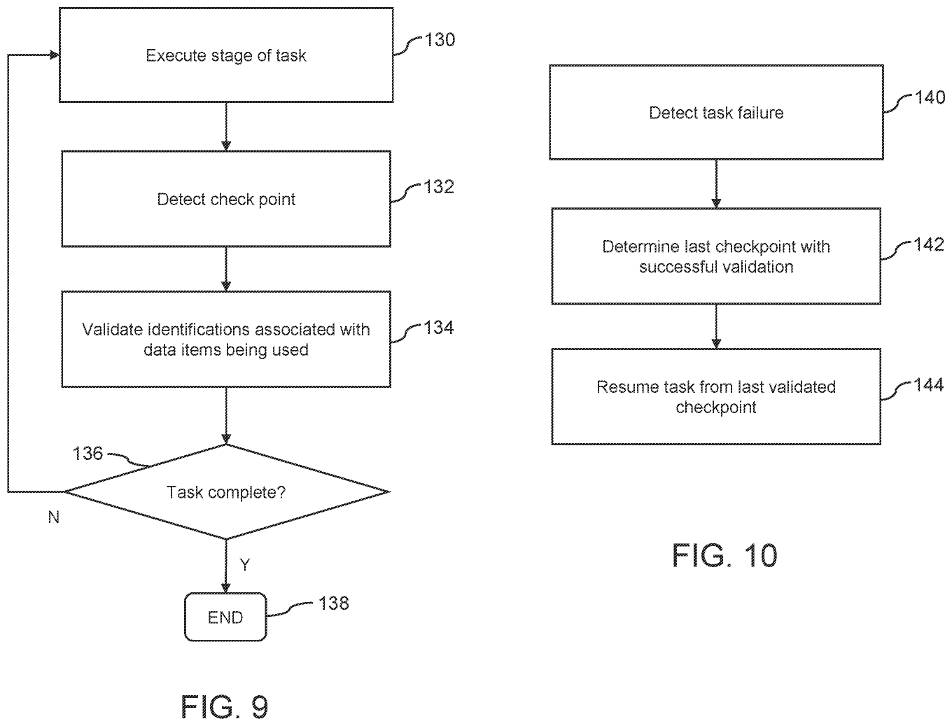

Referring now to FIG. 9, a flow chart is provided illustrating example operations for executing a task 24 having multiple intermediate checkpoints 60, e.g., as shown in FIG. 5. At block 130, a stage of the task 24 is executed and, at block 132, a checkpoint 60 is detected.

At block 134, IDs 30 associated with the data items 31, 33 being used (e.g., input data 50, 52, generated data 54, etc.) are validated, e.g., by executing the validation step 62 or ID check 34. At block 136, the batch processor 18 determines if the task 24 is complete (e.g., an end task condition 64 is detected). If not, the process may repeat at block 130 to execute the next stage in the task 24. If the task 24 is determined to be complete at block 136, the process ends at block 138.

Referring now to FIG. 10, a flow chart is provided illustrating example operations for resuming a failed task 24 from an intermediate checkpoint 60 based on a prior successful validation step 62. At block 140, a task failure is detected and at block 142, the last checkpoint 60 with a successful validation is determined (if any).

At block 144, the task 24 may be resumed from the last validated checkpoint 60 to ensure that the data items 50, 52, 54 have not been compromised while avoiding the need to start over completely.

Therefore, as data 28 in a cross-tenant/cross-user job is fetched for processing, by having a user/account ID 30 associated with, or otherwise corresponding to (e.g., stored with) the data 31 that is being fetched and processed when batching, validation of the data 31 may be made shortly or just before the time when it is being processed, rather than as the data 31 is being fetched. In this way, cross-contamination may be avoided by ensuring ownership after the point when the cross-contamination (or malicious activity) could occur (e.g., between fetching the data 31 and writing processed/modified/mutated data 32 back to the database 20).

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10 or any entity or component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method, comprising:
in executing a batch processing job comprising at least one task to be performed for each of a plurality of entities associated with a plurality of different security zones spanning at least one security boundary:
obtaining a plurality of data items each associated with entities of the plurality of entities, the data items to be used in performing the at least one task;
associating data items of the plurality of data items with indications of the entities of the plurality of entities associated therewith; and
while performing the at least one task, prior to mutating data based on one or more of the data items of the plurality of data items, cross-referencing the indications associated with the plurality of data items to validate ownership of the data items associated with a corresponding entity of the plurality of entities associated therewith.

2. The method of claim 1, wherein the cross-referencing comprises comparing the indications associated with the plurality of data items to confirm that the indications match.

3. The method of claim 2, further comprising:
in performing the cross-referencing while repeating the method, responsive to determining that at least one of the indications does not match at least one other indication, disallowing the mutating.

4. The method of claim 3, further comprising initiating an error condition responsive to disallowing the mutating.

5. The method of claim 1, wherein the indications identify a corresponding user or account associated with the plurality of data items to cross-reference against an entity requesting that the at least one task be performed.

6. The method of claim 1, wherein the at least one task comprises reading a particular data item, mutating the particular data item, validating the corresponding indication using a plurality of related data items of the corresponding associated entity, and writing the particular data item back to a database.

7. The method of claim 1, wherein the batch processing job is executed in a distributed computing system.

8. The method of claim 1, wherein the plurality of data items comprises any one or more of trigger parameters, metadata, and orchestration data.

9. The method of claim 8, wherein the plurality of data items comprises data generated while executing the particular task.

10. The method of claim 1, wherein the at least one task comprises at least one checkpoint during execution thereof, and the method further comprises validating ownership of the data items associated with the corresponding entity at each checkpoint.

11. The method of claim 10, further comprising:
responsive to a failure during execution of the at least one task, determining that a particular checkpoint of the at least one checkpoint has validated the ownership of the data items; and
resuming the at least one task from the particular checkpoint.

12. The method of claim 1, further comprising:
responsive to the ownership of the data items being validated, complete the at least one task by mutating the data and writing the mutated data back to a database.

13. A computer system comprising:
at least one processor; and
at least one memory, the at least one memory comprising processor executable instructions that, when executed by the at least one processor, cause the computer system to:
in executing a batch processing job comprising at least one task to be performed for each of a plurality of entities associated with a plurality of different security zones spanning at least one security boundary:
obtain a plurality of data items each associated with entities of the plurality of entities, the data items to be used in performing the at least one task;
associate data items of the plurality of data items with indications of the entities of the plurality of entities associated therewith; and
while performing the at least one task, prior to mutating data based on one or more of the data items of the plurality of data items, cross-reference the indications associated with the plurality of data items to validate ownership of the data items associated with a corresponding entity of the plurality of entities associated therewith.

14. The computer system of claim 13, wherein the cross-referencing comprises comparing the indications associated with the plurality of data items to confirm that the indications match.

15. The computer system of claim 14, further comprising instructions that, when executed by the at least one processor, cause the computer system to:
in performing the cross-referencing while repeating the operations, responsive to determining that at least one of the indications does not match at least one other indication, disallow the mutating.

16. The computer system of claim 15, further comprising instructions that, when executed by the at least one processor, cause the computer system to initiate an error condition responsive to disallowing the mutating.

17. The computer system of claim 13, wherein the indications identify a corresponding user or account associated with the plurality of data items to cross-reference against an entity requesting that the at least one task be performed.

18. The computer system of claim 13, wherein the at least one task comprises at least one checkpoint during execution thereof, and the method further comprises validating ownership of the data items associated with the corresponding entity at each checkpoint.

19. The computer system of claim 18, further comprising instructions that, when executed by the at least one processor, cause the computer system to:
responsive to a failure during execution of the at least one task, determine that a particular checkpoint of the at least one checkpoint has validated the ownership of the data items; and
resume the at least one task from the particular checkpoint.

20. A computer-readable medium comprising processor executable instructions that, when executed by a processor of a computer system, cause the computer system to:
in executing a batch processing job comprising at least one task to be performed for each of a plurality of entities associated with a plurality of different security zones spanning at least one security boundary:
obtain a plurality of data items each associated with entities of the plurality of entities, the data items to be used in performing the at least one task;
associate data items of the plurality of data items with indications of the entities of the plurality of entities associated therewith; and
while performing the at least one task, prior to mutating data based on one or more of the data items of the plurality of data items, cross-reference the indications associated with the plurality of data items to validate ownership of the data items associated with a corresponding entity of the plurality of entities associated therewith.
